(19) United States
(12) Patent Application Publication
(10) Pub. No.: US 2024/0288585 A1
(43) Pub. Date: Aug. 29, 2024

(54) A-GNSS DATA ACCESS FOR OUT-OF-COVERAGE LOCALIZATION

(71) Applicant: Nokia Technologies Oy, Espoo (FI)

(72) Inventors: Oana-Elena BARBU, Aalborg (DK); Diomidis MICHALOPOULOS, Munich (DE)

(21) Appl. No.: 18/570,983

(22) PCT Filed: Jun. 25, 2021
(86) PCT No.: PCT/EP2021/067506

§ 371 Date: Dec. 15, 2023

(51) Int. Cl. G01S 19/06

(52) U.S. Cl. CPC G01S 19/06

(57) ABSTRACT

Improved techniques of acquiring A-GNSS data include enabling a terminal UE (T-UE) that is out-of-coverage (OOC) in a 5G NR network to obtain A-GNSS data from an aid UE (A-UE) that is in-coverage in the 5G NR network, the A-UE being configured to access the A-GNSS data from a network node and to provide assistance to a T-UE, and the T-UE being configured to broadcast, via a sidelink connection, a request to obtain A-GNSS data.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's LTE upgrade path for mobile networks. In LTE, base stations or access points (APs), which are referred to as enhanced Node AP (eNBs), provide wireless access within a coverage area or cell. In LTE, mobile devices, or mobile stations are referred to as user equipment (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, e.g., above 6 GHz. For fifth generation wireless systems (5G), an access architecture for deployment of cellular radio equipment employing mmWave radio spectrum has been proposed. Other example spectrums may also be used, such as cmWave radio spectrum (e.g., 3-30 GHz).

### SUMMARY

According to an example implementation, a method includes receiving, by a terminal user equipment from a network node of a network prior to the terminal user equipment being out of coverage with respect to the network, configuration data representing a configuration of the terminal user equipment to request assistance in obtaining assisted global navigation satellite system data. The method further includes broadcasting over a sidelink connection, by the terminal user equipment while the terminal user equipment is out of coverage with respect to the network, request data representing a request to obtain the assisted global navigation satellite system data. The method further includes obtaining over the sidelink connection, by the terminal user equipment from at least one aid user equipment in coverage with respect to the network, a message including the assisted global navigation satellite system data.

According to an example implementation, an apparatus includes at least one processor and at least one memory including computer program code, the at least one memory and the computer program code configured to, with the at least one processor, cause the apparatus at least to receive, by a terminal user equipment from a network node of a network prior to the terminal user equipment being out of coverage with respect to the network, configuration data representing a configuration of the terminal user equipment to request assistance in obtaining assisted global navigation satellite system data. The at least one memory and the computer program code are further configured to, with the at least one processor, cause the apparatus at least to broadcast over a sidelink connection, by the terminal user equipment while the terminal user equipment is out of coverage with respect to the network, request data representing a request to obtain the assisted global navigation satellite system data. The at least one memory and the computer program code are further configured to, with the at least one processor, cause the apparatus at least to obtain over the sidelink connection, by the terminal user equipment from at least one aid user equipment in coverage with respect to the network, a message including the assisted global navigation satellite system data.

According to an example implementation, an apparatus includes means for receiving, by a terminal user equipment from a network node of a network prior to the terminal user equipment being out of coverage with respect to the network, configuration data representing a configuration of the terminal user equipment to request assistance in obtaining assisted global navigation satellite system data. The apparatus also includes means for broadcasting over a sidelink connection, by the terminal user equipment while the terminal user equipment is out of coverage with respect to the network, request data representing a request to obtain the assisted global navigation satellite system data. The apparatus further includes means for obtaining over the sidelink connection, by the terminal user equipment from at least one aid user equipment in coverage with respect to the network, a message including the assisted global navigation satellite system data.

According to an example implementation, a computer program product includes a computer-readable storage medium and storing executable code that, when executed by at least one data processing apparatus, is configured to cause the at least one data processing apparatus to receive, by a terminal user equipment from a network node of a network prior to the terminal user equipment being out of coverage with respect to the network, configuration data representing a configuration of the terminal user equipment to request assistance in obtaining assisted global navigation satellite system data. The executable code, when executed by at least one data processing apparatus, is also configured to cause the at least one data processing apparatus to broadcast over a sidelink connection, by the terminal user equipment while the terminal user equipment is out of coverage with respect to the network, request data representing a request to obtain the assisted global navigation satellite system data. The executable code, when executed by at least one data processing apparatus, is also configured to cause the at least one data processing apparatus to obtain over the sidelink connection, by the terminal user equipment from at least one aid user equipment in coverage with respect to the network, a message including the assisted global navigation satellite system data.

According to an example implementation, a method includes receiving, by an aid user equipment from a network node of a network, the aid user equipment being in coverage with respect to the network, configuration data representing a configuration of the aid user equipment to provide assistance to a terminal user equipment in obtaining assisted global navigation satellite system data, the terminal user equipment being out of coverage with respect to the network.

According to an example implementation, an apparatus includes at least one processor and at least one memory including computer program code, the at least one memory and the computer program code configured to, with the at least one processor, cause the apparatus at least to receive, by an aid user equipment from a network node of a network, the aid user equipment being in coverage with respect to the network, configuration data representing a configuration of the aid user equipment to provide assistance to a terminal user equipment in obtaining assisted global navigation satellite system data, the terminal user equipment being out of coverage with respect to the network.

According to an example implementation, an apparatus includes means for receiving, by an aid user equipment from a network node of a network, the aid user equipment being in coverage with respect to the network, configuration data representing a configuration of the aid user equipment to provide assistance to a terminal user equipment in obtaining assisted global navigation satellite system data, the terminal user equipment being out of coverage with respect to the network.

According to an example implementation, a computer program product includes a computer-readable storage medium and storing executable code that, when executed by at least one data processing apparatus, is configured to cause the at least one data processing apparatus to receive, by an aid user equipment from a network node of a network, the aid user equipment being in coverage with respect to the network, configuration data representing a configuration of the aid user equipment to provide assistance to a terminal user equipment in obtaining assisted global navigation satellite system data, the terminal user equipment being out of coverage with respect to the network.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a digital communications network according to an example implementation.

FIG. 2 is a diagram illustrating a configuration for providing A-GNSS data to an out-of-coverage user equipment, according to an example implementation.

FIG. 3 is a sequence diagram illustrating providing A-GNSS data to an out-of-coverage user equipment, according to an example implementation.

FIG. 4 is a flow chart illustrating providing A-GNSS data to an out-of-coverage user equipment according to an example implementation.

FIG. 5 is a flow chart illustrating providing A-GNSS data to an out-of-coverage user equipment according to an example implementation.

FIG. 6 is a block diagram of a node or wireless station (e.g., base station/access point, relay node, or mobile station/user device) according to an example implementation.

### DETAILED DESCRIPTION

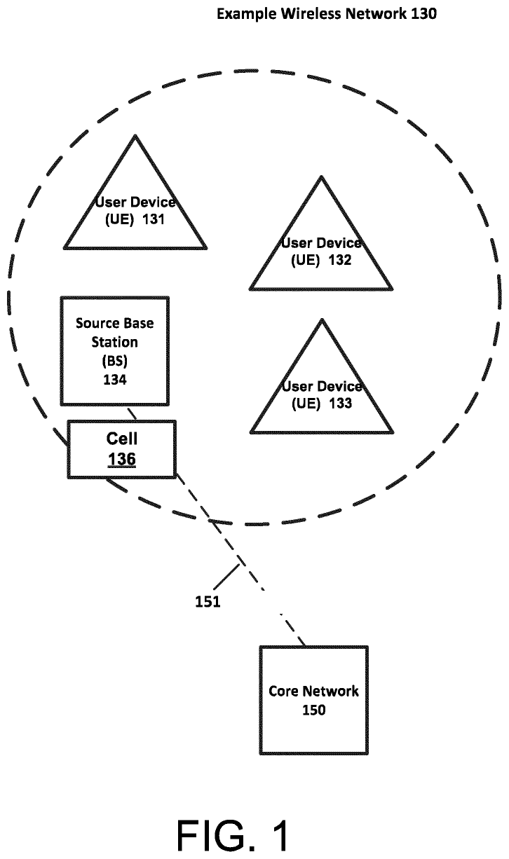

FIG. 1 is a block diagram of a digital communications system such as a wireless network 130 according to an example implementation. In the wireless network 130 of FIG. 1, user devices 131, 132, and 133, which may also be referred to as mobile stations (MSs) or user equipment (UEs), may be connected (and in communication) with a base station (BS) 134, which may also be referred to as an access point (AP), an enhanced Node B (eNB), a gNB (which may be a 5G base station) or a network node. At least part of the functionalities of an access point (AP), base station (BS) or (e)Node B (eNB) may be also be carried out by any node, server or host which may be operably coupled to a transceiver, such as a remote radio head. BS (or AP) 134 provides wireless coverage within a cell 136, including the user devices 131, 132 and 133. Although only three user devices are shown as being connected or attached to BS 134, any number of user devices may be provided. BS 134 is also connected to a core network 150 via an interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/serving cell change of user devices between BSs, one or more gateways that may forward data and control signals between the BSs and packet data networks or the Internet, and other control functions or blocks.

The various example implementations may be applied to a wide variety of wireless technologies, wireless networks, such as LTE, LTE-A, 5G (New Radio, or NR), cmWave, and/or mmWave band networks, or any other wireless network or use case. LTE, 5G, cmWave and mmWave band networks are provided only as illustrative examples, and the various example implementations may be applied to any wireless technology/wireless network. The various example implementations may also be applied to a variety of different applications, services or use cases, such as, for example, ultra-reliability low latency communications (URLLC), Internet of Things (IOT), time-sensitive communications (TSC), enhanced mobile broadband (eMBB), massive machine type communications (MMTC), vehicle-to-vehicle (V2V), vehicle-to-device, etc. Each of these use cases, or types of UEs, may have its own set of requirements.

Assisted Global Navigation Satellite System (A-GNSS) is a system that provides necessary Global Navigation Satellite System (GNSS) configuration data to a user equipment (UE) via the 5G New Radio (NR) random access network (RAN), instead of the slow satellite link. Specifically, before acquiring its own GNSS location, a UE needs to obtain a set of parameters, called orbital information, regarding the location and configuration (e.g. clock) of several satellites.

The orbital data can be downloaded from the satellite directly, or from a 5G NR GNSS server which already acquired and stored the data itself. The former option has a couple of disadvantages:
The data rate of the satellite link is only 50 b/s, so UE downloading is lengthy and unreliable since the signal may be lost before the download is complete, and
In urban scenarios, the satellite link may exhibit multipath and/or high attenuation, and the signal quality may be too poor to allow for a correct decoding of the downloaded orbital data.

These shortcomings may introduce delays of up to twelve minutes in acquiring a GNSS location, therefore A-GNSS systems were introduced as a fallback solution. In A-GNSS, the 5G NR network deploys an A-GNSS server which downloads the orbital data and store it in a terrestrial location.

In addition, another type of A-GNSS data that the 5G NR network can assist the UE with is a GNSS-correction data. This data helps the UE correct its own GNSS-acquired position and it is computed by an A-GNSS NR server by comparing the location of a fixed reference device (placed at known location) with the same device location estimated by GNSS.

The orbital and correction data are known generically as A-GNSS data. A GNSS-capable UE connects to the A-GNSS NR server and obtains A-GNSS data via 5G NR interface, at a significantly higher data rate.

To connect to the A-GNSS NR server according to a conventional approach, the UE should access the following.
An A-GNSS subscription, and
Coverage of a 5G NR network.

While the first condition is ensured via billing by the network operator, the second one may become problematic when the UE is out-of-coverage (OOC). Lacking the 5G NR network support, the UE cannot compute its own GNSS location (or for that matter any type of location, e.g. NR), resulting in poor or missing localization capability for the UE. This becomes problematic particularly for emergency services, where the UE may need to be located very fast.

In contrast to the above-described conventional approach to acquiring A-GNSS data, improved techniques of acquiring A-GNSS data include enabling a terminal UE (T-UE) that is out-of-coverage (OOC) in a 5G NR network to obtain A-GNSS data from an aid UE (A-UE) that is in-coverage in the 5G NR network, the A-UE being configured to access the A-GNSS data from a network node. In some implementations, the transfer of A-GNSS data from A-UE to T-UE is performed via a sidelink connection.

Advantageously, in the above-described improved technique of accessing A-GNSS data from a A-GNSS NR server allows a OOC T-UE to access A-GNSS data via a A-UE, resulting in improved localization capability for that T-UE. Specifically, advantages of the improved technique include the following.
The improved technique provides a solution for public safety uses cases, where a UE which is out of cellular coverage is assisted by a sidelink UE to be able to accurate locate itself via A-GNSS.
The improved technique provides a faster alternative (e.g., hundreds of milliseconds) to the slow satellite link download (e.g. measured latencies of up to 12 minutes), since latency is critical in public safety use cases.
The improved technique is attractive for network operators as it minimizes the cost of network deployment in remote areas-it is rather based on transferring assistance data to the terminal (or target) UE via nearby UEs.
The improved technique requires minimum effort by the aid UE (A-UE) to provide the assistance information to terminal UE, as the A-UE can forward the assistance data without decrypting or decoding it.

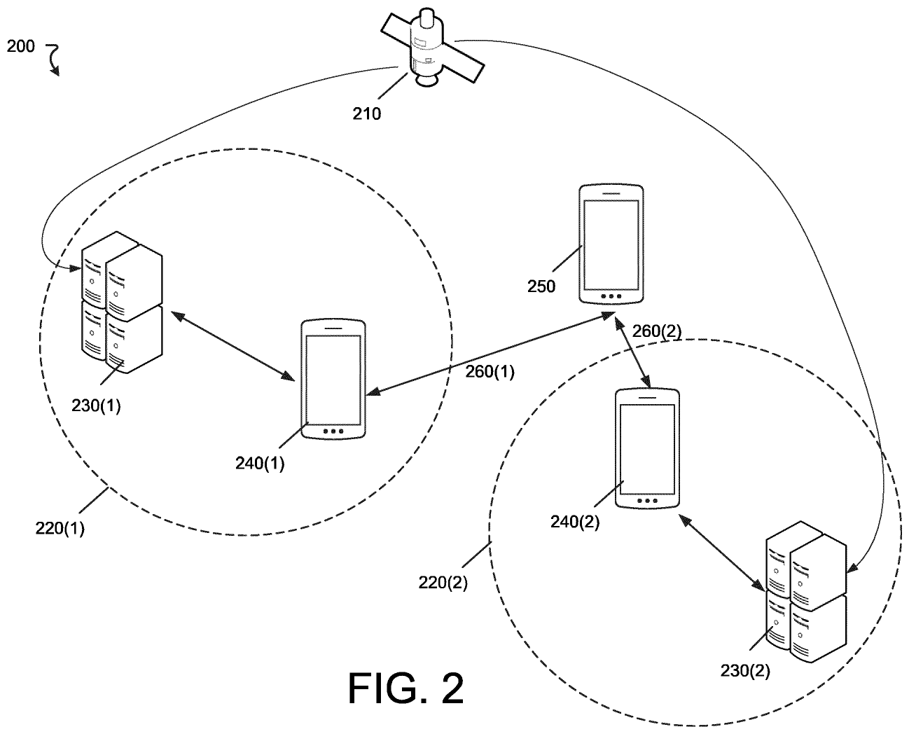

FIG. 2 is a diagram illustrating a configuration 200 for providing A-GNSS data to an out-of-coverage user equipment. The configuration 200 includes a satellite 210, two A-GNSS servers 230(1,2) defining respective two coverage areas 220(1,2) within which two respective A-UEs 240(1,2) are located. A T-UE 250 is located outside of the coverage areas 220(1,2).

According to the above-described improved technique, respective sidelink channels 260(1,2) between A-UEs 240(1,2) and T-UE 250 to transfer A-GNSS assistance data from respective A-GNSS servers via A-UEs 240(1,2) that are within coverage to the T-UE 250 which is OOC.

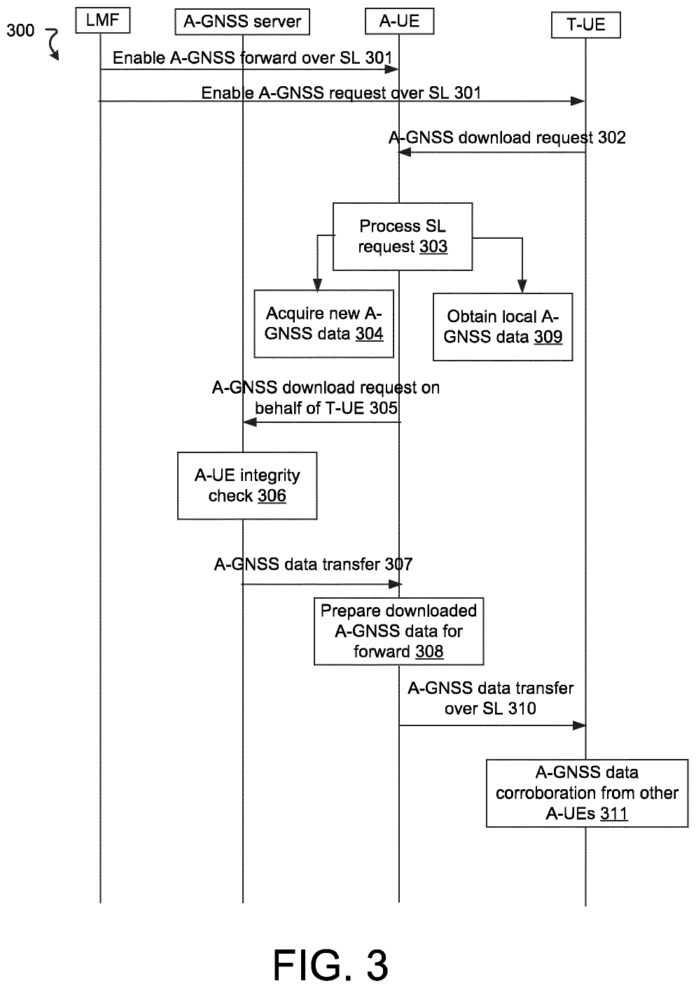

As is discussed with regard to FIG. 3, the improved techniques include the following features:
Configuring the T-UE and A-UE (or A-UEs) to cooperate with the purpose of extending the A-GNSS NR coverage,
Requesting and obtaining a set of necessary information elements from the T-UE to the A-UE(s), which are used for the following:
   Allowing an A-UE to estimate a set of quality metrics (e.g. the distance) characterizing the link to the T-UE,
   Enabling the A-UE(s) to obtain and forward to the terminal UE the relevant A-GNSS data.
Enabling the T-UE to combine A-GNSS data received from multiple A-UEs according to various metrics.

The above-described improved technique defines a process for A-UE(s) to obtain A-GNSS data from the network on behalf of the T-UE, based on processing conducted at the A-UE(s) along with a procedural framework that involves both the A-UE(s) and the T-UE.

The improved technique defines a framework through which an OOC T-UE is enabled to obtain A-GNSS data, and ultimately compute its own GNSS location in a fast and reliable way. Specifically, the improved technique presents a new signal exchange between the OOC T-UE and other nearby A-UEs. An A-UE is used to provide up-to-date A-GNSS data to the T-UE while the T-UE is outside of the 5G NR coverage.

FIG. 3 is a sequence diagram illustrating a process 300 for providing A-GNSS data to an out-of-coverage user equipment, i.e., a T-UE.

At 301, a location management function (LMF) (or, in some implementations, a location server) configures a T-UE and an A-UE to respectively request and provide assistance in obtaining A-GNSS data when the request comes in an OOC scenario.

At 302, the T-UE broadcasts over sidelink (SL) a request to download A-GNSS data. In some arrangements, the broadcast request includes at least one of the following.
A T-UE identifier uniquely identifying T-UE as subscriber to the A-GNSS service.
A latency indicator indicating an urgency of GNSS location acquisition.
An OOC flag indicating that T-UE is out of 5G NR coverage.
Measurement capabilities of the T-UE with respect to a sidelink connection.
A coarse T-UE location as obtained directly via GNSS but without A-GNSS data from the terrestrial network. This helps A-UEs identify an area of interest of the T-UE.
A transmit (Tx) power of the broadcast over SL. Such a power measurement is used by the A-UE to compare with the received power and thus obtain an estimate of the distance between T-UE and A-UE.

At 303, the A-UE (in some implementations, one of a plurality of A-UEs) previously configured to listen for the above broadcast (e.g. by the 5G NR LMF as in step 1), detect the call by T-UE and verify the following.
a) Whether the A-UE can obtain A-GNSS data on behalf of T-UE. This requires the A-UE to, at least be in coverage and have been empowered to download data not intended for the A-UE at 304. For this possibility to occur, at 305 an integrity of the A-UE has been validated by the network and the A-UE has been deemed non-malicious via processes that led to step 301.
b) Whether the A-UE has already downloaded A-GNSS data and the A-GNSS data is not deprecated, e.g. a difference between a download timestamp and T-UE's request timestamps are less than a specified threshold.
   i) The threshold, in some implementations, is inversely proportional to a speed of the satellite (e.g., satellite 210 in FIG. 2). The threshold may be set by the network and be part of the configuration at 301.
   ii) The download may have happened via an A-GNSS NR channels, or via the satellite link directly, and may have been intended to be used by A-UE itself, or by another OOC UE.
c) Whether battery/power levels allow A-UE to support the process 300.

d) A strength of the received broadcast from the T-UE, e.g. reference signal received power (RSRP). The signal strength serves as an indication of the distance between T-UE and A-UE and, in some implementations, is used to decide whether assisting the T-UE is indeed useful for the A-UE. For example, if the two UEs are too far apart, the cost involved in performing the procedure may not be justified, since the assistance data may not be useful to T-UE.

If the verification at 303 is successful, and, e.g., the difference between the download timestamp and T-UE's request timestamps is greater than the specified threshold, the process 300 branches to 304, at which the A-UE triggers a download and forward (DF) of A-GNSS data on behalf of the T-UE.

In this branch at 305, in some implementations, the A-UE uses a new DF UL request using the T-UE identifier. This DF UL request may be conveyed over physical uplink control channel (PUCCH) to the A-GNSS NR server in a message that contains at least the following.
The timestamp of the T-UE request,
At least a portion of content of the broadcast request from 302. In some arrangements, such a portion includes any combination of the T-UE identifier, the latency indicator, the OOC flag, and/or the measurement capabilities of the T-UE with respect to the sidelink connection.
   In some implementations, the A-UE may not necessarily be able to decode the assistance data by the network, as the A-UE may not necessarily have a subscription for A-GNSS with the network. In this case, the A-UE forwards the encrypted information as is, i.e., without performing decryption and/or decoding.

In this branch at 306, the A-GNSS server performs the integrity check discussed above on the A-UE. If the integrity check is successful, then at 307, the A-GNSS server transfers A-GNSS data to the A-UE on behalf of the T-UE. At 308, upon receiving the A-GNSS from the A-GNSS server as a download, the A-UE prepares the downloaded A-GNSS data for forwarding to the T-UE over the sidelink connection.

In an alternative branch, the difference between the download timestamp and T-UE's request timestamps is less than the specified threshold. In this case, at 309, the A-UE prepares the A-GNSS stored in a local storage device for forwarding to the T-UE over the sidelink connection.

At 310, the A-UE transmits the A-GNSS data it had either downloaded form the A-GNSS server or obtained from a local storage device to the T-UE. In some implementations, the A-UE transmits the A-GNSS data to the UE in a message, in which the message includes an indicator of the distance between A-UE and the A-GNSS server. This indicator may be used by T-UE to weight the assistance data in comparison to that received from other A-UEs.

At 311, the T-UE receives the A-GNSS data from the A-UE. In some implementations, the T-UE performs at least one of the following operations.
a) The T-UE computes a distance indicator to A-UE, e.g. by measuring the reference signal received power (RSRP) of a sidelink signal.
b) The T-UE decodes the A-GNSS data received over the sidelink connection. In some implementations, the T-UE may receive the A-GNSS data from one or more A-UEs; in this case, the T-UE is configured to corroborate the A-GNSS data received from the one or more A-UEs. For example,
   i) The T-UE may weigh A-GNSS data from closer A-UEs more than that from farther UEs.
   ii) A-GNSS data from closer A-GNSS servers may weigh more than that from farther servers. An indicative distance to the server via A-UE may be computed by combining, for example, the indicator of the distance between A-UE and the A-GNSS server and the distance indicator to A-UE.

Having combined A-GNSS data from multiple A-UEs, T-UE applies the refined orbital parameters to compute own GNSS location.

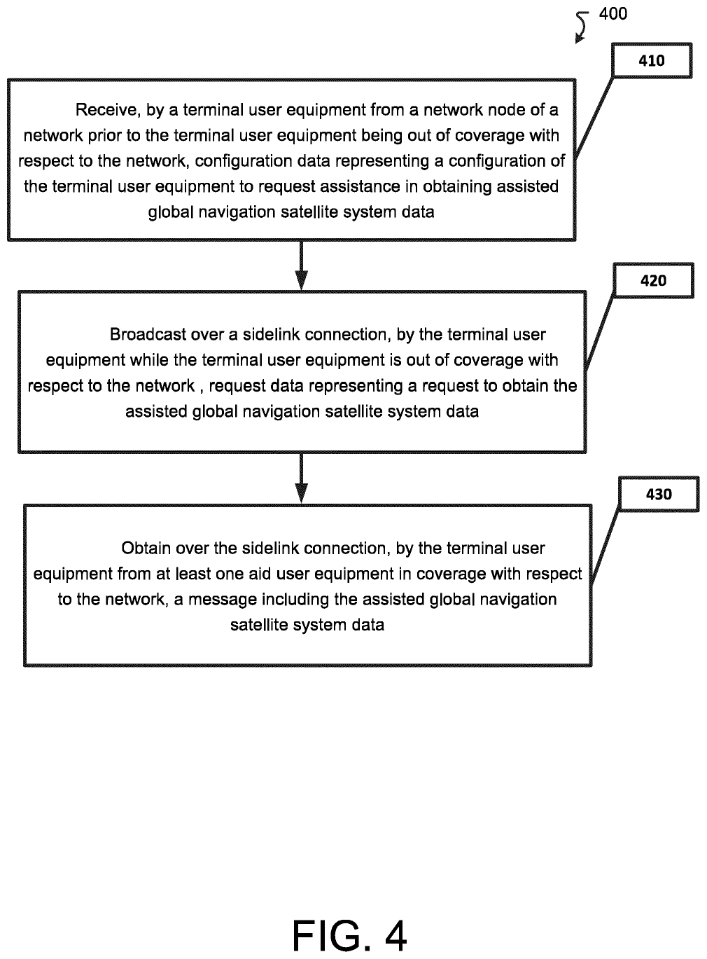

Example 1-1: FIG. 4 is a flow chart illustrating a method of estimating time synchronization accuracy according to an example implementation. At 410, the method includes receiving, by a terminal user equipment from a network node of a network prior to the terminal user equipment being out of coverage with respect to the network, configuration data representing a configuration of the terminal user equipment to request assistance in obtaining assisted global navigation satellite system data. At 820, the method includes broadcasting over a sidelink connection, by the terminal user equipment while the terminal user equipment is out of coverage with respect to the network, request data representing a request to obtain the assisted global navigation satellite system data. At 830, the method includes obtaining over the sidelink connection, by the terminal user equipment from at least one aid user equipment in coverage with respect to the network, a message including the assisted global navigation satellite system data.

Example 1-2: According to an example implementation of example 1-1, wherein the request data includes identification data identifying the terminal user equipment as having rights to obtain the assisted global navigation satellite system data.

Example 1-3: According to an example implementation of any of examples 1-1 or 1-2, wherein the request data includes a latency indicator indicating a level of urgency to obtaining the assisted global navigation satellite system data.

Example 1-4: According to an example implementation of any of examples 1-1 to 1-3, wherein the request data includes a flag indicating that the terminal user equipment is out of coverage with respect to the network at the time of broadcasting the request data.

Example 1-5: According to an example implementation of any of examples 1-1 to 1-4, wherein the request data includes capability data indicating measurement capabilities with respect to the sidelink connection.

Example 1-6: According to an example implementation of any of examples 1-1 to 1-5, wherein the method further comprises obtaining a coarse location for the terminal user equipment directly from a global navigation satellite system; and wherein the request data includes coarse location data representing the obtained coarse location.

Example 1-7: According to an example implementation of any of examples 1-1 to 1-6, wherein the request data includes transmit power data indicating a Tx power of the broadcast over the sidelink connection.

Example 1-8: According to an example implementation of any of examples 1-1 to 1-7, wherein message further includes distance data representing a distance between the at least one aid user equipment and the network node.

Example 1-9: According to an example implementation of example 1-8, wherein the method further comprises obtaining over the sidelink connection, by the terminal user equipment from a second aid user equipment, a second message including the assisted global navigation satellite system data and second distance data representing a second distance between the second aid user equipment and a second network node; and generating a first weight and a second weight for the message and the second message, respectively, based on the distance and the second distance, respectively.

Example 1-10: According to an example implementation of any of examples 1-1 to 1-9, wherein the method further comprises obtaining over the sidelink connection, by the terminal user equipment from a second aid user equipment, a second message including second assisted global navigation satellite system data; combining the assisted global navigation satellite system data and the second assisted global navigation satellite system data to produce combined data; and determining a global navigation satellite system position based on the combined data.

Example 1-11: According to an example implementation of any of examples 1-1 to 1-10, wherein the method further comprises measuring a reference signal received power; and determining a distance between the terminal user equipment and the at least one aid user equipment based on the measured reference signal received power.

Example 1-12: An apparatus comprising means for performing a method of any of examples 1-1 to 1-11.

Example 1-13: A computer program product including a non-transitory computer-readable storage medium and storing executable code that, when executed by at least one data processing apparatus, is configured to cause the at least one data processing apparatus to perform a method of any of examples 1-1 to 1-11.

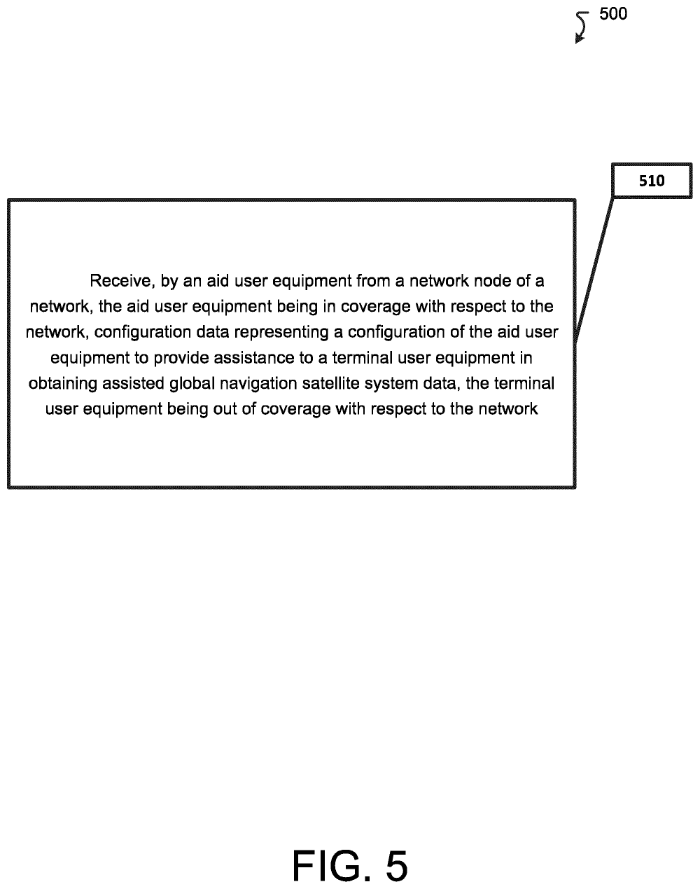

Example 2-1: FIG. 5 is a flow chart illustrating a method of estimating time synchronization according to an example implementation. At 510, the method includes receiving, by an aid user equipment from a network node of a network, the aid user equipment being in coverage with respect to the network, configuration data representing a configuration of the aid user equipment to provide assistance to a terminal user equipment in obtaining assisted global navigation satellite system data, the terminal user equipment being out of coverage with respect to the network.

Example 2-2: According to an example implementation of example 2-1, wherein the method further comprises receiving, from the terminal user equipment over a sidelink connection, request data representing a request to obtain the assisted global navigation satellite system data; obtaining the assisted global navigation satellite system data from the network node after transmitting the request data; and transmitting the assisted global navigation satellite system data to the terminal user equipment.

Example 2-3: According to an example implementation of example 2-2, wherein the method further comprises transmitting, to the network node, second request data representing a second request to download the assisted global navigation satellite system data; and receiving the assisted global navigation satellite system data from the network node after transmitting the second request data.

Example 2-4: According to an example implementation of example 2-3, wherein the assisted global navigation satellite system data is received from the network node in response to the aid user equipment passing an integrity check.

Example 2-5: According to an example implementation of any of examples 2-3 or 2-4, wherein the second request data includes a timestamp indicating a time at which the second request was transmitted.

Example 2-6: According to an example implementation of any of examples 2-3 to 2-5, wherein the second request data includes at least one of (i) identification data identifying the terminal user equipment as having rights to obtain the assisted global navigation satellite system data, (ii) a latency indicator indicating a level of urgency to obtaining the assisted global navigation satellite system data, (iii) a flag indicating that the terminal user equipment is out of coverage with respect to the network, or (iv) capability data indicating measurement capabilities of the terminal user equipment with respect to the sidelink connection.

Example 2-7: According to an example implementation of any of examples 2-2 to 2-6, wherein the method further comprises downloading the assisted global navigation satellite system data from the network node to a storage device accessible to the aid user equipment according to a specified schedule; and retrieving the assisted global navigation satellite system data from the storage device.

Example 2-8: According to an example implementation of example 2-7, wherein the assisted global navigation satellite system data is downloaded from the network node in response to the aid user equipment passing an integrity check.

Example 2-9: According to an example implementation of any of examples 2-7 or 2-8, wherein the downloaded assisted global navigation satellite system data has a timestamp, and wherein the method further comprises selecting one of (i) downloading the assisted global navigation satellite system data from the network node to the storage device according to the specified schedule or (ii) transmit a new request to the network node for the assisted global navigation satellite system data, the selecting being based on the timestamp.

Example 2-10: An apparatus comprising means for performing a method of any of examples 2-1 to 2-9.

Example 2-11: A computer program product including a non-transitory computer-readable storage medium and storing executable code that, when executed by at least one data processing apparatus, is configured to cause the at least one data processing apparatus to perform a method of any of examples 2-1 to 2-9

### List of Example Abbreviations

| | |
|---|---|
| LMF | location management function |
| UE | user equipment |
| TRP | transmit receive point |
| LPP | LTE positioning protocol |
| A-GNSS | assisted GNSS |
| SL | sidelink |
| RSRP | reference signal received power |
| UL | uplink |
| DF | Download and forward |

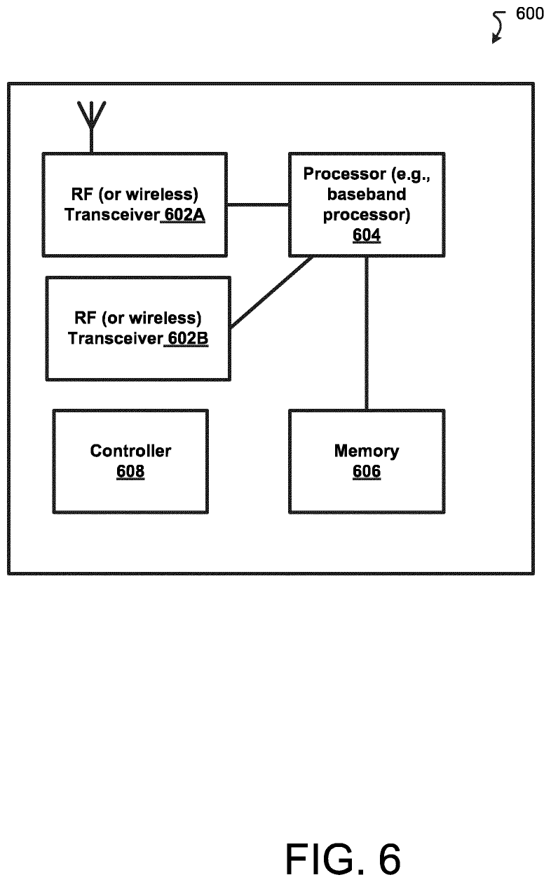

FIG. 6 is a block diagram of a wireless station (e.g., AP, BS, e/gNB, NB-IoT UE, UE or user device) 600 according to an example implementation. The wireless station 600 may include, for example, one or multiple RF (radio frequency) or wireless transceivers 602A, 602B, where each wireless transceiver includes a transmitter to transmit signals (or data) and a receiver to receive signals (or data). The wireless station also includes a processor or control unit/entity (controller) 604 to execute instructions or software and control transmission and receptions of signals, and a memory 606 to store data and/or instructions.

Processor 604 may also make decisions or determinations, generate slots, subframes, packets or messages for transmission, decode received slots, subframes, packets or messages for further processing, and other tasks or functions described herein. Processor 604, which may be a baseband processor, for example, may generate messages, packets, frames or other signals for transmission via wireless transceiver 602 (602A or 602B). Processor 604 may control transmission of signals or messages over a wireless network, and may control the reception of signals or messages, etc., via a wireless network (e.g., after being down-converted by wireless transceiver 602, for example). Processor 604 may be programmable and capable of executing software or other instructions stored in memory or on other computer media to perform the various tasks and functions described above, such as one or more of the tasks or methods described above. Processor 604 may be (or may include), for example, hardware, programmable logic, a programmable processor that executes software or firmware, and/or any combination of these. Using other terminology, processor 604 and transceiver 602 together may be considered as a wireless transmitter/receiver system, for example.

In addition, referring to FIG. 6, a controller (or processor) 608 may execute software and instructions, and may provide overall control for the station 600, and may provide control for other systems not shown in FIG. 6 such as controlling input/output devices (e.g., display, keypad), and/or may execute software for one or more applications that may be provided on wireless station 600, such as, for example, an email program, audio/video applications, a word processor, a Voice over IP application, or other application or software.

In addition, a storage medium may be provided that includes stored instructions, which when executed by a controller or processor may result in the processor 604, or other controller or processor, performing one or more of the functions or tasks described above.

According to another example implementation, RF or wireless transceiver(s) 602A/602B may receive signals or data and/or transmit or send signals or data. Processor 604 (and possibly transceivers 602A/602B) may control the RF or wireless transceiver 602A or 602B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G uses multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. An apparatus, comprising:
at least one processor; and
at least one memory including computer program code;
the at least one memory and the computer program code configured to cause the apparatus at least to:
receive, by a terminal user equipment from a network node of a network prior to the terminal user equipment being out of coverage with respect to the network, configuration data representing a configuration of the terminal user equipment to request assistance in obtaining assisted global navigation satellite system data;
broadcast over a sidelink connection, by the terminal user equipment while the terminal user equipment is out of coverage with respect to the network, request data representing a request to obtain the assisted global navigation satellite system data; and
obtain over the sidelink connection, by the terminal user equipment from at least one aid user equipment in coverage with respect to the network, a message including the assisted global navigation satellite system data.

2. The apparatus as in claim 1, wherein the request data includes identification data identifying the terminal user equipment as having rights to obtain the assisted global navigation satellite system data.

3. The apparatus as in claim 1, wherein the request data includes a latency indicator indicating a level of urgency to obtaining the assisted global navigation satellite system data.

4. The apparatus as in claim 1, wherein the request data includes a flag indicating that the terminal user equipment is out of coverage with respect to the network at the time of broadcasting the request data.

5. The apparatus as in claim 1, wherein the request data includes capability data indicating measurement capabilities with respect to the sidelink connection.

6. The apparatus as in claim 1, wherein the at least one memory and the computer program code are further configured to cause the apparatus at least to:
obtain a coarse location for the terminal user equipment directly from a global navigation satellite system, and
wherein the request data includes coarse location data representing the obtained coarse location.

7. The apparatus as in claim 1, wherein the request data includes transmit power data indicating a Tx power of the broadcast over the sidelink connection.

8. The apparatus as in claim 1, wherein message further includes distance data representing a distance between the at least one aid user equipment and the network node,

[symbol]

9. The apparatus as in claim 8, wherein the at least one memory and the computer program code are further configured to cause the apparatus at least to:
obtain over the sidelink connection, by the terminal user equipment from a second aid user equipment, a second message including the assisted global navigation satellite system data and second distance data representing a second distance between the second aid user equipment and a second network node; and
generate a first weight and a second weight for the message and the second message, respectively, based on the distance and the second distance, respectively.

10. The apparatus as in claim 1, wherein the at least one memory and the computer program code are further configured to cause the apparatus at least to:
obtain over the sidelink connection, by the terminal user equipment from a second aid user equipment, a second message including second assisted global navigation satellite system data; and
combine the assisted global navigation satellite system data and the second assisted global navigation satellite system data to produce combined data; and
determine a global navigation satellite system position based on the combined data.

11. The apparatus as in claim 1, wherein the at least one memory and the computer program code are further configured to cause the apparatus at least to:
measure a reference signal received power of a sidelink signal; and
determine a distance between the terminal user equipment and the at least one aid user equipment based on the measured reference signal received power.

12. A method, comprising:
receiving, by a terminal user equipment from a network node of a network prior to the terminal user equipment being out of coverage with respect to the network, configuration data representing a configuration of the terminal user equipment to request assistance in obtaining assisted global navigation satellite system data;
broadcasting over a sidelink connection, by the terminal user equipment while the terminal user equipment is out of coverage with respect to the network, request data representing a request to obtain the assisted global navigation satellite system data; and
obtaining over the sidelink connection, by the terminal user equipment from at least one aid user equipment in coverage with respect to the network, a message including the assisted global navigation satellite system data.

13. An apparatus, comprising:
at least one processor; and
at least one memory including computer program code;
the at least one memory and the computer program code configured to cause the apparatus at least to:
receive, by an aid user equipment from a network node of a network, the aid user equipment being in coverage with respect to the network, configuration data representing a configuration of the aid user equipment to provide assistance to a terminal user equipment in obtaining assisted global navigation satellite system data, the terminal user equipment being out of coverage with respect to the network.

14. The apparatus as in claim 13, wherein the at least one memory and the computer program code are further configured to cause the apparatus at least to:
receive, from the terminal user equipment over a sidelink connection, request data representing a request to obtain the assisted global navigation satellite system data; and
obtain the assisted global navigation satellite system data from the network node after receiving the request data; and
transmit the assisted global navigation satellite system data to the terminal user equipment.

15. The apparatus as in claim 14, wherein the at least one memory and the computer program code configured to obtain the assisted global navigation satellite system data from the network node are further configured to:
transmit, to the network node, second request data representing a second request to download the assisted global navigation satellite system data; and
receive the assisted global navigation satellite system data from the network node after transmitting the second request data.

16. The apparatus as in claim 15, wherein the assisted global navigation satellite system data is received from the network node in response to the aid user equipment passing an integrity check.

17. The apparatus as in claim 15, wherein the second request data includes a timestamp indicating a time at which the second request was transmitted.

18. The apparatus as in claim 15, wherein the second request data includes at least one of (i) identification data identifying the terminal user equipment as having rights to obtain the assisted global navigation satellite system data, (ii) a latency indicator indicating a level of urgency to obtaining the assisted global navigation satellite system data, (iii) a flag indicating that the terminal user equipment is out of coverage with respect to the network, or (iv) capability data indicating measurement capabilities of the terminal user equipment with respect to the sidelink connection.

19. The apparatus as in claim 14, wherein the at least one memory and the computer program code configured to obtain the assisted global navigation satellite system data from the network node is further configured to:
downloading the assisted global navigation satellite system data from the network node to a storage device accessible to the aid user equipment according to a specified schedule; and
retrieve the assisted global navigation satellite system data from the storage device.

20. The apparatus as in claim 19, wherein the assisted global navigation satellite system data is downloaded from the network node in response to the aid user equipment passing an integrity check.

21-24. (canceled)
